(19) United States
(12) Patent Application Publication
(10) Pub. No.: US 2024/0095619 A1
(43) Pub. Date: Mar. 21, 2024

(54) SYSTEMS AND METHODS TO PRIORITIZE UNITS OF WORK WITHIN A COLLABORATION ENVIRONMENT

(71) Applicant: Asana, Inc., San Francisco, CA (US)

(72) Inventor: Alexander Hood, San Francisco, CA (US)

(21) Appl. No.: 17/028,369

(22) Filed: Sep. 22, 2020

(51) Int. Cl. G06F 9/50

(52) U.S. Cl. CPC G06F 9/50

(57) ABSTRACT

Systems and methods to prioritize units of work within a collaboration environment are disclosed. Exemplary implementations may: manage environment state information maintaining a collaboration environment, wherein managing the environment state information includes maintaining temporal queues of units of work assigned to users organized in chronological order based on individual end dates; detect occurrence of prioritization events for the temporal queues, the prioritization events being associated with criteria for prioritizing the units of work; in response to the detected occurrence of the prioritization events, generate prioritized queues of the units of work from the temporal queues in accordance with the criteria; effectuate presentation of a user interface of the collaboration environment displaying the prioritized queues; and/or perform other operations.

### FIELD OF THE DISCLOSURE

The present disclosure relates to systems and methods to prioritize units of work within a collaboration environment.

### BACKGROUND

Collaboration environments, sometimes referred to as integrated collaboration environments, may enable users to assign projects, tasks, or other assignments to assignees (e.g., other users) to complete. A collaboration environment may comprise an environment in which a virtual team of users does its work. A collaboration environment may enable users to work in a more organized and efficient manner. A collaboration environment may integrate features and/or functionality such as web-based conferencing and collaboration, desktop videoconferencing, and/or instant message into a single easy-to-use, intuitive interface.

### SUMMARY

One aspect of the present disclosure relates to a system configured to prioritize units of work within a collaboration environment. After an absence from work, users may scramble to prioritize what needs to be done in order to “catch up.” Although units of work (sometimes referred to as “tasks”) may be organized and presented based on due date/expected completion date, the actual prioritization the user should employ may sometimes not coincide with these approaching due dates alone. This may lead to productivity loses, missed due dates, and general disarray. In one or more implementations described herein, prioritization may be customized when a user returns from an absence based on certain criteria. For example, prioritization may be set based on expected workload required to complete the units of work, where units of work with lower expected workload may be prioritized first to get them “out of the way.” Prioritization may be derived from the extent of other users' engagement on tasks. For example, a unit of work which includes a threshold quantity of comments may be prioritized over others, as this may reflect that more users are being attentive to the unit of work. Prioritization may be set by managing users who indicate certain units of work should be tackled earlier on when the user returns. Prioritization may be based on other criteria. In some implementations, alternatively and/or in addition to prioritization following an absence, prioritization may be triggered based on user-initiated requests to prioritize. One or more user interface elements may be presented in a user interface of the collaboration environment. Individual user interface elements may correspond to different sets of criteria for prioritizing. As such, a user may select a desired user interface element to elicit a prioritization of their units of work based on the desired set of criteria.

One or more implementations of a system to prioritize units of work within a collaboration environment may include one or more hardware processors configured by machine-readable instructions. Executing the machine-readable instructions may cause the one or more hardware processors to facilitate prioritizing units of work within a collaboration environment. The machine-readable instructions may include computer program components. The computer program components may include one or more of an environment state component, a prioritization component, a user interface component, and/or other components.

The environment state component may be configured to manage environment state information maintaining a collaboration environment and/or other information. The collaboration environment may be configured to facilitate interaction by users with the collaboration environment. The environment state information may define one or more of user records, work unit records, and/or other records. User records may include presence information and/or other information. The presence information may indicate presence and/or absence of the users from the collaboration environment. The presence information may be used to track a user's leave of absence from work. The work unit records may specify units of work assigned to individual users within the collaboration environment, and/or other information. Individual units of work may be associated with individual end dates and/or other information.

In some implementations, managing the environment state information may include maintaining temporal queues of the units of work assigned to the users. Individual temporal queues may represent the units of work assigned to individual users organized in chronological order based on the individual end dates and/or other dates. By way of non-limiting illustration, the units of work may include a first set of units of work assigned to a first user. The first set of units of work may be represented in a first temporal queue.

The prioritization component may be configured to determine criteria for prioritizing the units of work. In some implementations, criteria for prioritizing the units of work may be determined in response to the presence information indicating the presence of the individual users following the absence of the individual users. By way of non-limiting illustration, in response to the presence information indicating the presence of the first user following the absence of the first user, a first set of criteria for prioritizing may be determined.

The prioritization component may be configured to generate prioritized queues of the units of work from the temporal queues in accordance with the criteria. The prioritized queues may represent subsets of the units of work identified for prioritization. By way of non-limiting illustration, a first prioritized queue from the first temporal queue may be generated in accordance with the first set of criteria. The first prioritized queue may represent a first subset of units of work from the first set of units of work.

The user interface component may be configured to effectuate presentation of a user interface of the collaboration environment. The user interface may display the prioritized queues and/or other information. As such, the users may access the units of work identified for prioritization via the prioritized queues. By way of non-limiting illustration, the user interface may display the first prioritized queue to facilitate access to the first subset of units of work by the first user.

In some implementations, the prioritization component may be configured to obtain input information conveying user input into the user interface of the collaboration environment. The user input may include user-initiated requests to prioritize the units of work in the temporal queues based on criteria for prioritizing. By way of non-limiting illustration, the user input may include a first user-initiated request by the first user to prioritize the units of work in the first set of units of work assigned to the first user. The first user-initiated request may be associated with a second set of criteria.

The prioritization component may be configured to, in response to the user input, generate prioritized queues of the units of work from the temporal queues in accordance with the criteria associated with the user-initiated requests. By way of non-limiting illustration, responsive to obtaining the user input including the first user-initiated request, a second prioritized queue may be generated from the first temporal queue in accordance with the second set of criteria. The second prioritized queue may represent a second subset of units of work from the first set of units of work.

In some implementations, multiple types of prioritization may be provided. By way of non-limiting illustration, the first user-initiated request may be directed to prioritizing the units of work in the first subset of units of work associated with the first prioritized queue. Accordingly, the second prioritized queue may be generated from the first prioritized queue in accordance with the second set of criteria. This may represent a prioritization following a leave of absence which is then prioritized again based on user input.

As used herein, any association (or relation, or reflection, or indication, or correspondency) involving servers, processors, client computing platforms, and/or another entity or object that interacts with any part of the system and/or plays a part in the operation of the system, may be a one-to-one association, a one-to-many association, a many-to-one association, and/or a many-to-many association or N-to-M association (note that N and M may be different numbers greater than 1).

As used herein, the term “obtain” (and derivatives thereof) may include active and/or passive retrieval, determination, derivation, transfer, upload, download, submission, and/or exchange of information, and/or any combination thereof. As used herein, the term “effectuate” (and derivatives thereof) may include active and/or passive causation of any effect. As used herein, the term “determine” (and derivatives thereof) may include measure, calculate, compute, estimate, approximate, generate, and/or otherwise derive, and/or any combination thereof.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to prioritize units of work within a collaboration environment, in accordance with one or more implementations.

FIG. 2 illustrates a method to prioritize units of work within a collaboration environment, in accordance with one or more implementations.

FIG. 3 illustrates a user interface, in accordance with one or more implementations.

FIG. 4 illustrates a user interface, in accordance with one or more implementations.

### DETAILED DESCRIPTION

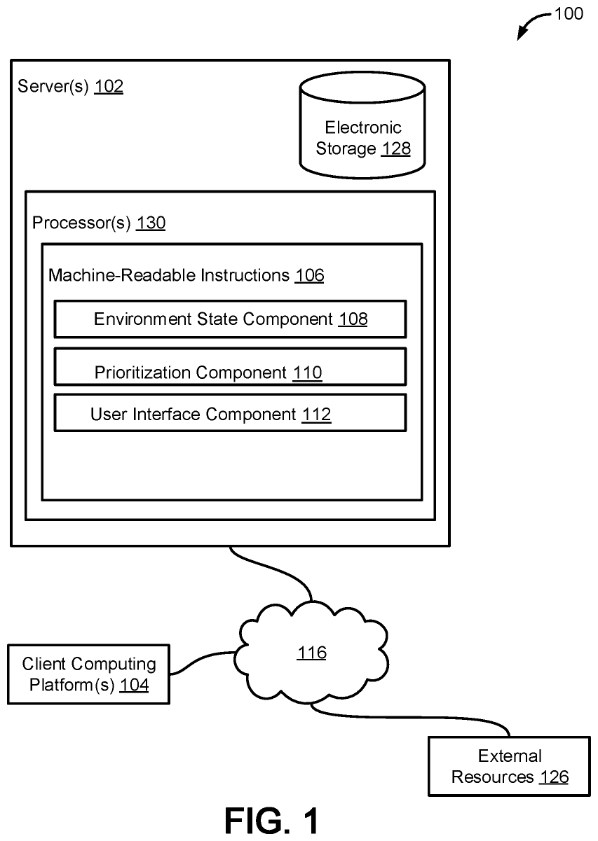

FIG. 1 illustrates a system 100 configured to prioritize units of work within a collaboration environment, in accordance with one or more implementations. The system 100 may include features and/or functionality to detect occurrence of prioritization events associated with criteria for prioritizing units of work. The prioritization events may be related to one or more of a user returning from a leave of absence, specific user input requesting prioritization, and/or other events. In some implementations, prioritization may be customized when a user returns from the absence based on certain criteria. In some implementations, one or more user interface elements may be presented in a user interface of the collaboration environment. Individual user interface elements may correspond to different sets of criteria for prioritizing. As such, a user may select a desired user interface element to elicit a prioritization of their units of work based on the corresponding set of criteria.

In some implementations, system 100 may include one or more of one or more servers 102, one or more client computing platforms 104, external resources 126, and/or other components. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may include one or more of non-transitory electronic storage 128, one or more processors 130 configured by machine-readable instructions 106, and/or other components. Machine-readable instructions 106 may include one or more instruction components. The instruction components may include computer program components. Executing the machine-readable instructions 106 may cause server(s) 102 to facilitate prioritizing units of work within a collaboration environment. The computer program components may include one or more of an environment state component 108, a prioritization component 110, a user interface component 112, and/or other instruction components.

Environment state component 108 may be configured to manage environment state information and/or other information used in maintaining a collaboration environment. The collaboration environment may be configured to facilitate interaction by users within the collaboration environment. The environment state information may include one or more of user information, prioritization information, objective information, work information, and/or other information used to define, support, and/or otherwise maintain a collaboration environment.

The user information may include values of user parameters. The values of the user parameters may be organized in user records corresponding to users interacting with and/or viewing the collaboration environment. The values of the user parameters may include information describing the users, their actions within the collaboration environment, their settings, and/or other user information; and/or metadata associated with the users, their actions within the environment, their settings, and/or other user information. Individual ones of the users may be associated with individual ones of the user records. A user record may define values of the user parameters associated with a given user.

The values of the user parameters may, by way of non-limiting example, specify one or more of: a user name, a group parameter, a user account, a user role information, a user department, descriptive user content, a to-email, a from-email, a photo, an organization, a workspace, one or more projects (which may include project parameters defined by one or more work unit records), one or more business objectives, one or more items of work (which may include one or more unit of work parameters defined by one or more unit of work records), one or more user comments, one or more teams the user belongs to, one or more of the user display settings (e.g., colors, size, project order, task order, other unit of work order, etc.), one or more authorized applications, one or more interaction parameters (e.g., indicating a user is working on/worked on a given unit of work, a given user viewed a given work unit of work, a given user selected a given unit of work, a timeframe a given user last interacted with and/or worked on a given unit of work, a time period that a given unit of work has been idle, and/or other interaction parameters), presence information indicating presence and/or absence of the users from the collaboration environment, one or more notification settings, one or more progress parameters, status information for one or more work units the user is associated with (units of work assigned to the user, assigned to other users by the user, completed by the user, past-due date, and/or other information), progress information for one or more business objectives the user is associated with (business objectives owned by the user, of which the user is a collaborator, fulfilled by the user, past-due date, and/or other information), one or more performance metrics of a given user (e.g., how many units of work the user has completed, how quickly the user completed the units of work, how quickly the user completes certain types of work units, the efficiency of the user, bandwidth of the user, activity level of the user, how many business objectives the user has helped fulfill through their completion of units of work, etc.), application access information (e.g., username/password for one or more third-party applications), one or more favorites and/or priorities, schedule information, and/or other information.

Presence information may indicate presence based on one or more of a user logging into the collaboration environment, a user activating the collaboration environment by launching the collaboration environment a browser and/or a dedicated application, and/or performing some action within the collaboration environment. Presence information may indicate absence based on a user logging out of the collaboration environment. Presence information may indicate absence based on a lack of user activity following a presence, whether or a not a user logs out. In some implementations, presence information may indicate absence based on a specific indication of absence (e.g., a scheduled vacation, leave, and/or other information). In some implementations, presence information may indicate a length of a time period of an absence. A length of a time period of an absence may be determined based on a span of days between consecutive indications of presence.

User role information may specify individual roles of the individual users in the individual units of work and/or business objectives. A role may represent a position of an individual user. The position may be specified based on a description of one or more of a job title, level, stage, and/or other descriptions of position. The role may be specified with respect to a company as a whole, a particular unit of work, a particular business objective, and/or other considerations. By way of non-limiting illustration, a role may include one or more of chief executive officer (or other officer), owner, manager, supervisor, accountant, associate, employee, entry level, midlevel, senior, administrator, director, foreman, engineer, product developer, human resource officer, artist, art director, and/or other description.

The work information may include values of one or more work unit parameters. The values of the work unit parameters may be organized in work unit records corresponding to units of work managed, created, and/or assigned within the collaboration environment. A given work unit may have one or more assignees and/or team members working on the given work unit. Work units may include one or more to-do items, action items, objectives, and/or other units of work one or more users should accomplish and/or plan on accomplishing. Units of work may be created by a given user for the given user and/or created by the given user and assigned to one or more other users. Individual units of work may include one or more of an individual project, an individual task, an individual sub-task, and/or other units of work assigned to and/or associated with one or more users. Individual units of work may include one or more digital content items. An individual unit of work may include an individual digital content item by virtue of the individual digital content item (and/or a copy or instance thereof) being attached and/or appended thereto. An individual unit of work may include an individual digital content item by virtue of the individual digital content item (and/or a copy or instance thereof) being accessible via the individual unit of work (e.g., via link, URL, a pointer, and/or other techniques to provide access). A digital content item may include one or more of an image, a video, an audio file, a PDF, a word document, and/or other digital content items. In some implementations, an individual unit of work may comprise an external unit of a work. An external unit of work may refer to a unit of work originating from a source external to the collaboration environment. A source external to the collaboration environment may include a source which specifically generates and/or defines units of work and/or a source from with units of work may be derived and/or inferred. By way of non-limiting illustration, a source external to the collaboration environment may include a word processing application wherein units of work may include comments embedded in a word document addressed to an other individual to address. In some implementations, a source external to the collaboration environment may include an application program with which users of the collaboration environment may engage in during a regular course of a workday.

Individual sets of work unit records may be defined by a record hierarchy. A record hierarchy may convey individual positions of work unit records (and their corresponding units of work) in the record hierarchy. By way of non-limiting illustration, a position may specify one or more of a work unit record being superior to another work unit record, a work unit record being subordinate to another work unit record, and/or other information. As a result, individual work unit records in the individual sets of work unit records may be subordinate to other individual work unit records in the individual sets of work unit records. For example, a work unit record may define a unit of work comprising a task, and a subordinate work unit record may define a unit of work comprising a sub-task to the task. A record hierarchy may define a relationship between work unit records. A work unit record may have some restrictions placed on it by virtue of having a subordinate work unit record. By way of non-limiting illustration, a work unit record may be restricted from access by one or more users unless and/or until a subordinate work unit record is completed and/or started. In some implementations, the work unit records may include a first work unit record describing a first unit of work assigned to a first user and/or other work unit records. The first unit of work may include a first digital content item and/or other information.

Individual work unit records may include hierarchical information defining a record hierarchy of the individual work unit records. The hierarchical information of a work unit record may include one or more of information identifying other work unit records associated in a record hierarchy the work unit record belongs to, a specification of the position of the work unit record in the hierarchy, restrictions and/or other relationships placed on the work unit record by virtue of its position, and/or other information.

In some implementations, as a consequence of the record hierarchies, the individual units of work described in the individual work unit records that are subordinate to the other individual work unit records may be subordinate to the individual units of work in the other individual work unit records.

In some implementations, the one or more work unit parameters may include one or more of a work assignment parameter, a work management parameter, work creation parameter, and/or other parameters. The values of the work assignment parameter may describe units of work assigned to the individual users. The values of the work management parameter may describe units of work managed by the individual users. The values of the work creation parameter may describe units of work created by the individual users.

In some implementations, the units of work may be described based on one or more of a unit of work name, a unit of work description, one or more unit of work dates (e.g., a start date, a due date or end date, a completion date, and/or dates), one or more members associated with a unit of work (e.g., an owner, one or more other project/task members, member access information, and/or other unit of work members and/or member information), a status parameter (e.g., an update, a hardcoded status update, a completed/incomplete/mark complete, a measured status, a progress indicator, quantity of sub-work units remaining for a given unit of work, completed work units in a given project, and/or other status parameter), one or more user comment parameters (e.g., permission for who may make comments such as an assignee, an assignor, a recipient, one or more followers, and/or one or more other interested parties; content of the comments; one or more times; presence or absence of the functionality of up-votes; one or more hard-coded responses; and/or other parameters), one or more interaction parameters (e.g., indicating a given unit of work is being worked on/was worked on, a given work unit of work was viewed, a given unit of work was selected, how long the given unit of work has been idle, a last interaction parameter indicating when and what user last interacted with the given unit of work, users that interacted with the given unit of work, quantity and/or content of comments on the unit of work, and/or other interaction parameters indicating sources of the interactions, context of the interactions, content of the interactions and/or time for the interactions), one or more digital content item attachments, notification settings, privacy, an associated URL, one or more interaction parameters (e.g., sources of the interactions, context of the interactions, content of the interactions, time for the interactions, and/or other interaction parameters), updates, ordering of units of work within a given unit of work (e.g., tasks within a project, subtasks within a task, etc.), state of a workspace for a given unit of work (e.g., application state parameters, application status, application interactions, user information, and/or other parameters related to the state of the workspace for a unit of work), hierarchical information, one or more custom fields (e.g., priority, cost, stage, and/or other custom fields), and/or other information.

The values of the work assignment parameter describing units of work assigned to the individual users may be determined based on one or more interactions by one or more users with a collaboration environment. In some implementations, one or more users may create and/or assign one or more unit of work to themselves and/or another user. In some implementations, a user may be assigned a unit of work and the user may effectuate a reassignment of the unit of work from the user or one or more other users.

In some implementations, values of the work assignment parameter may indicate that a status parameter of a unit of work has changed from “incomplete” to “marked complete” and/or “complete”. In some implementations, a status of complete for a unit of work may be associated with the passing of an end date associated with the unit of work. In some implementations, a status of “marked complete” may be associated with a user providing input via the collaboration environment at the point in time the user completes the unit of work (which may be before or after an end date).

In some implementations, managing by the environment state component 108 the environment state information may include maintaining temporal queues of the units of work assigned to the users. The temporal queues may be presented to the users in a user interface of the collaboration environment to facilitate access to the units of work. Individual temporal queues may represent the units of work assigned to individual users organized in chronological order based on the individual end dates and/or other dates (e.g., start dates) and/or other order. Individual temporal queues may be presented in a user interface based on one or more of a list view, a calendar view, and/or other views. The calendar view may be a calendar view by week, by more than one week (e.g., 1^{st} through 15^{th}), by month, by more than one month (e.g., May through July), and/or other calendar views. Units of work may be representing in a calendar view by user interface elements (e.g., icons, calendar entries, etc.). By way of non-limiting illustration, the units of work may include a first set of units of work assigned to a first user. The first set of units of work may be represented in a first temporal queue. The first set of units of work may be organized in chronological order based on the individual end dates.

The objective information may include values of one or more objective parameters. The values of the objective parameters may be organized in objective records corresponding to business objectives managed, created, and/or owned within the collaboration environment. A given business objective may have one or more collaborators, and/or team members working on the given business objective. Business objectives may include one or more associated units of work one or more users should accomplish and/or plan on accomplishing. Business objectives may be created by a given user for the given user and/or created by the given user and assigned to be owned to one or more other users. Individual business objectives may include one or more of an individual goal, an individual sub-goal, and/or other business objectives assigned to be owned by a user and/or associated with one or more users.

Individual objective records may describe individual business objectives and identify sets of individual ones of the work unit records that specify the units of work associated with the individual business objectives. By way of non-limiting illustration, a first objective record may describe a first business objective and identify a set of work unit records that specifies a set of units of work associated with the first business objective.

Individual sets of objective records may be defined by an objective record hierarchy. An objective record hierarchy may convey individual positions of objective records (and their corresponding business objectives) in the objective record hierarchy. By way of non-limiting illustration, a position may specify one or more of an objective record being superior to one or more other objective records, an objective record being subordinate to one or more other objective records, and/or other information. As a result, individual objective records may be subordinate and/or superior to other individual objective records. For example, the objective records may further include a second objective record. The first objective record and the second objective record may be organized by a first objective record hierarchy specifying that the second objective record is subordinate to the first objective record.

An objective record may define a business objective comprising a progress towards fulfillment, and a subordinate objective record may define a business objective comprising a subordinate progress towards fulfillment to the subordinate business objective. An objective record hierarchy may define a relationship between objective records. The business objectives may be associated with a set of units of work that may indirectly facilitate progress toward fulfillment of the business objectives. The set of units of work may not directly contribute to the progress. By way of non-limiting illustration, a connection between the set of units of work and a corresponding business objective may be indirect in that completion of at least one of the units of work may have no direct impact on progress toward fulfillment of the business objective. The concept of “no direct impact” may mean that completion of the at least one unit of work may not cause progress toward fulfillment of the business objective without independent action outside of the at least one unit of work. Instead, the fulfillment of the at least one business objective may make such independent action more likely (e.g., through coercion, assistance, education, incentivization, reminder, etc.). However, in some implementations, business objectives may be associated with a set of units of work that may directly facilitate progress toward fulfillment of the business objectives. Accordingly, completion of the set of units of work may directly contribute to the progress toward fulfillment. Business objectives may be associated with an objectives and key result (OKR) goal-setting framework. Business objectives may be specified on one or more of a team basis, organization basis, and/or other specifications. In some implementations, business objectives may be characterized as user objectives. The user objectives may be associated with a set of units of work that may indirectly (and/or directly) facilitate progress toward fulfillment of the user objectives. User objectives may be specified on an individual user basis.

Individual objective records may include hierarchical information defining an objective record hierarchy of the individual objective records. The hierarchical information of an objective record may include one or more of information identifying other objective records associated in an objective record hierarchy the objective record belongs to, a specification of the position of the objective record in the hierarchy, other relationships placed on the objective record by virtue of its position, and/or other information.

In some implementations, as a consequence of the objective record hierarchies, the individual business objectives described in the individual objective records that are subordinate to the other individual objective records may be subordinate to the individual business objectives in the other individual objective records.

In some implementations, the one or more objective parameters may include one or more of an objective definition parameter, an objective owner parameter, an objective management parameter, an objective creation parameter, an objective progress parameter, and/or other parameters. The value of the objective definition parameter may describe the particular business objective. The values of the objective owner parameter may describe business objectives assigned to be owned by an individual user. The values of the objective management parameter may describe business objectives managed as collaborators by the individual users. The values of the objective creation parameter may describe business objectives created by the individual users.

In some implementations, the business objectives may be described based on one or more of a business objective name, a business objective description, one or more business objective dates (e.g., a start date, a due date, and/or dates), one or more members associated with a business objective (e.g., an owner, one or more other project/task members, member access information, and/or other business objective members and/or member information), progress information (e.g., an update, a hardcoded status update, a measured status, a progress indicator, quantity value remaining for a given business objective, completed work units in a given project, and/or other progress information), one or more interaction parameters, notification settings, privacy, an associated URL, one or more custom fields (e.g., priority, cost, stage, and/or other custom fields), and/or other information.

The values of the objective owner parameter describing business objectives owned by the individual users may be determined based on one or more interactions by one or more users with a collaboration environment. In some implementations, one or more users may create and/or assign ownership of one or more business objectives to themselves and/or another user. In some implementations, a user may be assigned to own a business objective and the user may effectuate a reassignment of ownership of the business objective from the user or one or more other users.

The prioritization information may define prioritization events and the criteria for prioritizing units of work associated therewith. The prioritization information may be organized in prioritization records. An individual prioritization record may define an individual prioritization event and a set of criteria associated with the individual prioritization event. The prioritization events may be events that initiate prioritizing the units of work assigned to the individual users (i.e., as otherwise represented in the temporal queues).

In some implementations, the prioritization events may comprise different prioritization types. The prioritization types may include a guided type, an unguided type, and/or other prioritization types. The guided type may correspond to user-initiated requests to prioritize. The unguided type may correspond to automated prioritization based on the environment state information and/or other information. The unguided type may correspond to automated prioritization that may not require explicit user input to request the prioritization.

The occurrence of the prioritization events of the guided type may be determined based on obtaining user input into a user interface. A set of user interface elements may be provided on the user interface to facilitate the user input. Individual user interface elements may correspond to different sets of criteria for prioritizing the units of work. The individual user interface elements may include indicia indicating what criteria they may be associated with.

The occurrence of the prioritization events of the unguided type may be determined based on monitoring presence information stored in user records and/or other information. In response to the presence information indicating the presence of the individual users following the absence of the individual users, a prioritization event may occur. The criteria for prioritizing may then be determined. At least some of the criteria may be determined based on a length of time of the absence. However, this is for illustrative purposes, and other criteria will be described in more detail herein, and may or may not be dependent on a particular type of prioritization event.

The criteria associated with the prioritization events may facilitate identifying which ones of the units of work assigned to the individual user are to be prioritized and thus included in a prioritized queue. The prioritized queues may represent subsets of the units of work identified for prioritization. In some implementations, the criteria for prioritizing the units of work may include one or more of selection criteria, ordering criteria, and/or other criteria.

The selection criteria may dictate which of the units of work from the temporal queues are identified for prioritization in the prioritized queues. The selection criteria may dictate selection of a given unit of work for prioritization based on one or more of an amount of time to complete the given unit of work (workload for the given unit of work), an amount of time available by the user to work over a given period of time (workload availability of the user), a creator of the given unit of work, an association the given unit of work with a project, an association the given unit of work with a business objective, a dependency of the given unit of work, an association the given unit of work with a team of users, values of one or more interaction parameters of the units of work, whether or not a user is mentioned in a comment section of a unit of work, who the assignee is, who is following the given unit of work (and/or the role of that person), a priority indication set for the given unit of work (e.g., specific indication of priority by an upper level employee), and/or other information. In some implementations, the given unit of work may have one or more other units of work dependent on it (i.e., the given unit of work must be completed before work one or more other units of work can be started). In some implementations, the given unit of work may be dependent on other units of work (e.g., that have been recently completed). In some implementations, the amount of time to complete the given unit of work, the creator, the project, the business objective, the team by which units of work are selected may be input or selected by the user (e.g., via user interface elements), modified by the user, input or selected by a user of a particular role (e.g., administrator, manager, etc.), modified by the user of the particular role, edited in other manners, and/or fixed by system 100. In some implementations, prioritization based on an amount of time available by the user to work over a given period of time may include prioritization based on how much time a user has in a given day (and/or other time period) to get things done. By way of non-limiting illustration, a 4 hour unit of work may be deprioritized if the user has 20 mins of work time that day. In some implementations, an amount of time available by the user to work over a given period of time may be determined based on workload of other tasks assigned to a user to complete over that given period of time, determined from an external calendar, and/or determined in other ways.

By way of non-limiting illustration, the selection criteria may dictate selection of a given unit of work from the temporal queue based on dependency (e.g., order in a record hierarchy) of the given unit of work, the amount of time to complete the given unit of work, and/or other criteria. The dependency may indicate that the given unit of work has a superior unit of work that cannot be completed until the given unit of work is completed. The amount of time to complete the given unit of work may be input as 45 minutes or less. Therefore, the units of work selected for inclusion in the prioritized queue may have the dependency of a superior unit of work and may be completed in 45 minutes or less.

The ordering criteria may dictate an order by which the units of work identified based on the selection criteria are to be presented as the prioritized queue. For example, the units of work may be ordered by one or more of ascending amount of time to complete the identified unit of work of the subset of the units of work (e.g., 2 mins-30 minutes), descending amount of time to complete the identified units of work (e.g., 30 minutes-2 minutes), creators of the identified units of work alphabetically (e.g., ascending or descending), projects of the identified units of work alphabetically (e.g., ascending or descending), end dates of the projects (i.e., soonest to farthest, or farthest to soonest), business objectives of the identified units of work alphabetically (e.g., ascending or descending), end dates of the business objective (i.e., soonest to farthest, or farthest to soonest), teams of users associated with the identified units of work, and/or other orderings. In some implementations, the user may modify the ordering criteria upon presentation of the prioritized queue via user interface elements. A set of user interface elements may be provided on the user interface to facilitate the user input and/or other user interaction with a user interface. By way of non-limiting example, user interface elements may include one or more of text input fields, drop down menus, check boxes, display windows, virtual buttons, and/or other elements configured to facilitate user interaction. As such, the user may select a dropdown menu to order the prioritized queue by projects rather than amount of time to complete the identified units of work, for example.

In some implementations, the prioritization records may be user-specified and/or determined based on user interaction history within the collaboration environment. In some implementations, the user may specify a prioritization event by defining the event and associated criteria and/or modify an existing prioritization event and associated criteria. In some implementations, determining the prioritization records based on the user interaction history may include learning from previous user interactions with the collaboration environment. The user interactions may be derived from one or more users of the system. For example, if a user typically (e.g., more than one instance and/or other frequency) prioritizes units of work that can be completed in one hour and assigned by their manager and/or other criteria, system 100 may automatically prioritize based on such criteria for that user. For example, if a user of a manager role typically prioritizes units of work based on a certain business objective and/or other criteria, system 100 may automatically prioritize the units of work for subordinate users of the manager user based on such criteria. In some implementations, the user interaction history may be determined by monitoring how users interact with temporal queues of units of work. This may include rearranging the order in which they are presented, determining the order in which they are completed (regardless of how they are presented in the queue), and/or other information.

The prioritization component 110 may be configured to detect occurrence of the prioritization events for the temporal queues of the units of work assigned to the users. The prioritization events may be associated with criteria for prioritizing the units of work. By way of non-limiting illustration, detecting occurrence of the prioritization events may include detecting occurrence of the first prioritization event for the first temporal queue of the first set of units of work assigned to the first user.

In some implementations, prioritization component 110 may be configured to obtain input information and/or other information. The input information may convey user input into the user interface of the client computing platform 104. The user input may include the user-initiated requests to prioritize and/or other user input. A set of user interface elements may be provided on the user interface to facilitate the user input and/or other user interaction with the user interface. As previously mentioned, the user interface elements may include one or more of text input fields, drop down menus, check boxes, display windows, virtual buttons, and/or other elements configured to facilitate user interaction. Individual user interface elements may correspond to different sets of criteria for prioritizing the units of work. For example, a first user interface element may dictate selecting units of work based on a particular creator and a second user interface element may dictate selecting units of work based on a certain dependency. Prioritization component 110 may be configured to detect the occurrence of the prioritization events of the guided type based on obtaining the input information.

The unguided type of prioritization event may correspond to automated prioritization based on the environment state information (i.e., the user input is not required). In some implementations, prioritization component 110 may be configured to monitor the presence information and/or other information stored in user records of the users. In response to the presence information indicating a presence following an absence, prioritization component 110 may be configured to detect the occurrence of the prioritization events of the unguided type. The criteria of the prioritization events of the unguided type may be determined based on one or more of a length of a time period of the absence, the units of work having the individual end dates that fall within the time period of the absence, the units of work having the individual end dates immediately following (e.g., within one or more days) the presence, and/or other criteria.

In some implementations, the length of the time period of the absence may be set by the user (e.g., via user interface elements), modified by the user, set by a user of a particular role (e.g., administrator, manager, etc.), modified by the user of the particular role, and/or edited in other manners. In some implementations, the length of the time period of the absence may be fixed (e.g., to four days). In some implementations, the individual end dates for the units of work immediately following the presence may be set by the user (e.g., via user interface elements), modified by the user, set by the user of the particular role (e.g., administrator, manager, etc.), modified by the user of the particular role, and/or edited in other manners. In some implementations, the individual end dates for the units of work immediately following the presence may be fixed. For example, the individual end dates for the units of work immediately following the presence may be set to three days by the user so that any individual end dates in the next three days are prioritized.

The prioritization component 110 may be configured to generate the prioritized queues of the units of work from the temporal queues (and/or other prioritized queues) in accordance with the criteria of the prioritization events. The generation of the prioritized queues may be in response to the detected occurrence of the prioritization events. The prioritized queues may represent subsets of the units of work identified for prioritization. By way of non-limiting illustration, responsive to detected occurrence of the first prioritization event, a first prioritized queue may be generated from the first temporal queue in accordance with the first set of criteria. The first prioritized queue may represent a first subset of units of work from the first set of units of work. In implementations where a prioritized queue may be prioritized again based on further criteria, the resulting prioritized queue may comprise a subset of the subset. By way of non-limiting illustration, by virtue of the units of work in the first prioritized queue being prioritized based on a second set of criteria, a second prioritized queue may be generated from the first prioritized queue in accordance with the second set of criteria. The second prioritized queue may represent a second subset of units of work from the first subset of units of work.

The user interface component 112 may be configured to effectuate presentation of individual user interfaces on individual client computing platforms of one or more client computing platforms 104. The user interface component 112 may be configured to effectuate presentation of a user interface of the collaboration environment. The user interface may display one or more of the units of work in work unit pages, business objectives, temporal queues, prioritized queues, and/or other information. By way of non-limiting illustration, the users may access the units of work identified for prioritization via the temporal and/or prioritized queues. As such, the user interface may display the first prioritized queue to facilitate access to the first subset of units of work by the first user.

In some implementations, the user interface may display representations of the prioritized queues in one or more of an ordered list view in accordance with the ordering criteria, an unordered list view, in the calendar view, and/or other views. In some implementations, the prioritized queues may include icons, graphics, text, and/or other elements. Selection of a unit of work from the prioritized queues may facilitate generating views displaying the unit of work selected (e.g., a work unit page for the unit of work). In some implementations, the presence information may be presented via the individual user interfaces as a presence statement. The presence statement may include a date and/or time of the last login of the user.

In some implementations, environment state information may be updated as users continue to interact with the collaboration environment over time. The environment state component 108 may store and/or archive the environment state information periodically and/or based on user request to archive. In some implementations, the environment state component 108 may store historical environment state information specifying historical user information, historical work information, historical objective information, user interaction history, and/or other information.

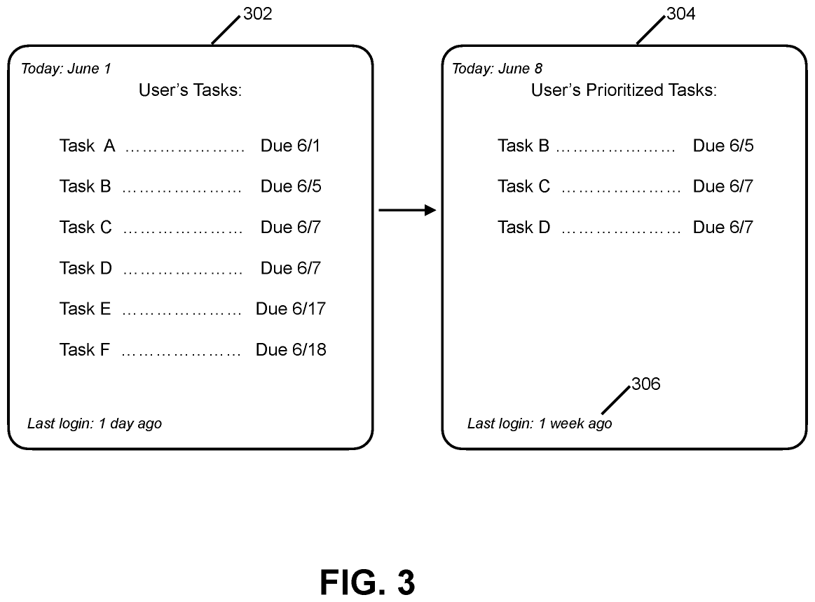

FIG. 3 illustrates user interfaces 302 and 304 depicting generating a prioritized queue from a temporal queue, in accordance with one or more implementations. User interface 302 may include the temporal queue for a user of which units of work (e.g., Task A-F) are organized in chronological order by individual end dates (e.g., Due 6/1-6/18). The temporal queue of user interface 302 may typically be used by the user to manage completion of the units of work assigned to them. Upon monitoring the presence information of the user, a presence of the user in the collaboration environment subsequent to an absence in the collaboration environment may be detected (i.e., prioritization event). In some implementations, the detection may be presented via the user interfaces by a presence statement 306 (e.g., “Last login: 1 day ago”, “Last login: 1 week ago”) stating when the user last logged into the collaboration environment. The detection, or prioritization event, may be associated with criteria to identify the units of work that have end dates within the time period of the absence. Thus, presentation of units of work may be effectuated. User interface 304 may include the prioritized queue for the user of which includes a subset of the units of work presented in user interface 302. The prioritized queue may include units of work (e.g., Task B, Task C, and Task D) with ends dates within the time period of the absence (e.g., between June 2 and June 7).

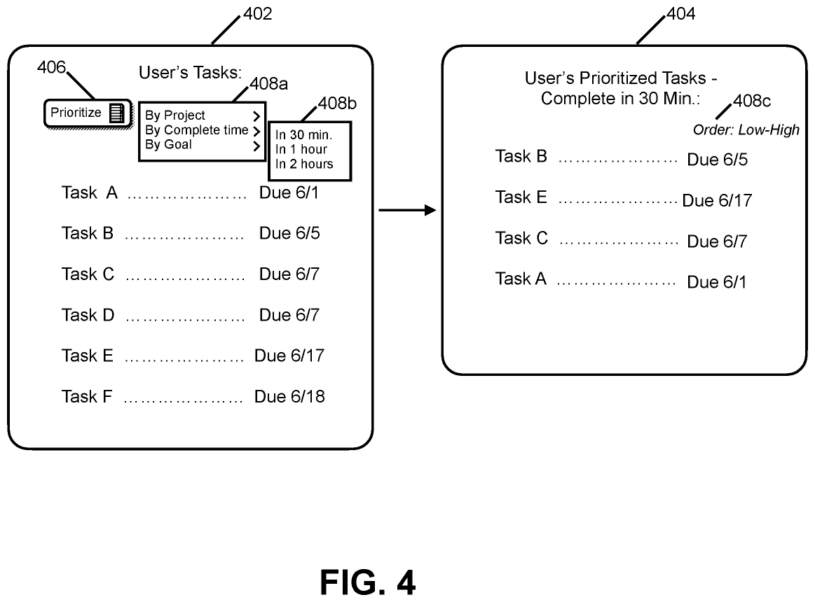

FIG. 4 illustrates a prioritization based on user selection of a user interface element. FIG. 4 shows a user interface 402 and a user interface 404. User interface 402 may include the temporal queue for a user of which units of work (e.g., Task A-F) are organized in chronological order by individual end dates (e.g., Due 6/1-6/18). The temporal queue of user interface 402 may typically be used by the user to manage completion of the units of work assigned to them. User interface 402 may include user interface element 406 of which the user may select to generate a prioritized queue from the temporal queue. Selecting user interface element 406 may cause a menu 408a to display. Menu 408a may present selection criteria by which a prioritized queue is generated (e.g., by Project, by Completion time, by Goal, etc.). The selection criteria may cause another menu, such as menu 408b, to display to further specify the selection criteria. Menu 408b may specify various completion times to prioritize the units of work of the temporal queue (e.g., In 30 min., In 1 hour, In 2 hours). Upon the user selecting one of the completion times (e.g., In 30 min.), the prioritized queue may be generated and presented via user interface 404. Thus, the prioritized queue may represent a subset of units of work (of the temporal queue) that can be completed in 30 minutes.

In some implementations, the order of the units of work included in the prioritized queue of user interface 404 may be ordered in accordance with ordering criteria. The ordering criteria may dictate to order the units of work from least time to complete to most time to complete (e.g., low-high). That is, Task B may only take 2 minutes to complete and Task A may take 30 minutes to complete. In some implementations, the ordering criteria may be modified by selecting a user interface element 408c (e.g., Order).

It is noted that FIGS. 3-4 are for illustrative purposes only and are not to be considered limiting. Instead, it is to be understood that user interfaces may be configured in other ways and/or including other elements in accordance with one or more implementations of the system 100 presented herein.

Referring back to FIG. 1, in some implementations, server(s) 102, client computing platform(s) 104, and/or external resources 126 may be operatively linked via one or more electronic communication links. For example, such electronic communication links may be established, at least in part, via a network 116 such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform may include one or more processors configured to execute computer program components. The computer program components may be configured to enable an expert or user associated with the given client computing platform to interface with system 100 and/or external resources 126, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 128, one or more processors 130, and/or other components. Server(s) 102 may include communication lines, or ports to enable the exchange of information with a network 116 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc..) or a drive (e.g., a disk drive, etc..). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, and/or other components. Processor(s) 130 may be configured to execute components 108, 110, and/or 112, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, and/or 112 are illustrated in FIG. 1 as being implemented within a single processing unit, in implementations in which processor(s) 130 includes multiple processing units, one or more of components 108, 110, and/or 112 may be implemented remotely from the other components. The description of the functionality provided by the different components 108, 110, and/or 112 described below is for illustrative purposes, and is not intended to be limiting, as any of components 108, 110, and/or 112 may provide more or less functionality than is described. For example, one or more of components 108, 110, and/or 112 may be eliminated, and some or all of its functionality may be provided by other ones of components 108, 110, and/or 112. As another example, processor(s) 130 may be configured to execute one or more additional components that may perform some or all of the functionality attributed below to one of components 108, 110, and/or 112.

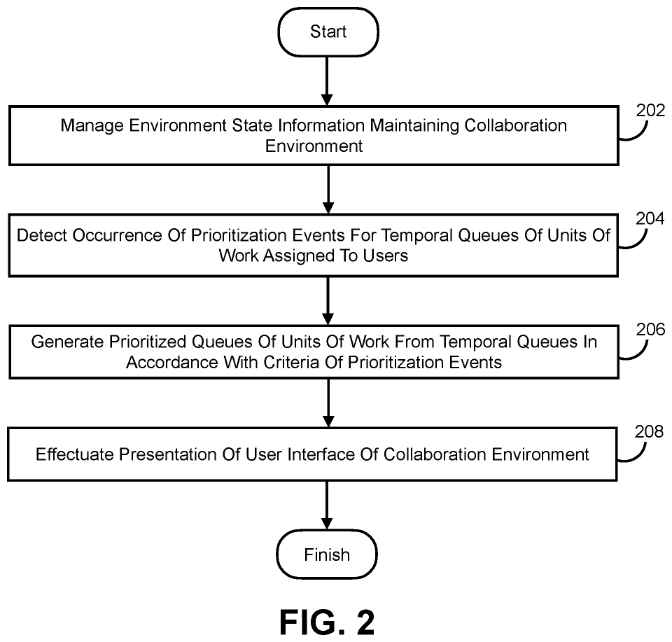

FIG. 2 illustrates a method 200 to prioritize units of work, in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may manage environment state information maintaining a collaboration environment and/or other information. The collaboration environment may be configured to facilitate interaction by users with the collaboration environment. The environment state information may define units of work assigned to individual users within the collaboration environment. Individual units of work may be associated with individual end dates. Managing the environment state information may include maintaining temporal queues of the units of work assigned to the users. Individual temporal queues may represent the units of work assigned to individual users organized in chronological order based on the individual end dates. Operation 202 may be performed by one or more hardware processors configured by machine-readable instructions including a component that is the same as or similar to environment state component 108, in accordance with one or more implementations.

An operation 204 may detect occurrence of prioritization events for the temporal queues of the units of work assigned to the users. The prioritization events may be associated with criteria for prioritizing the units of work. Operation 204 may be performed by one or more hardware processors configured by machine-readable instructions including a component that is the same as or similar to prioritization component 110, in accordance with one or more implementations.

An operation 206 may, in response to the detected occurrence of the prioritization events, generate prioritized queues of the units of work from the temporal queues in accordance with the criteria of the prioritization events. The prioritized queues may represent subsets of the units of work identified for prioritization. Operation 206 may be performed by one or more hardware processors configured by machine-readable instructions including a component that is the same as or similar to prioritization component 110, in accordance with one or more implementations.

An operation 208 may effectuate presentation of a user interface of the collaboration environment. The user interface may display the prioritized queues. Operation 208 may be performed by one or more hardware processors configured by machine-readable instructions including a component that is the same as or similar to user interface component 112, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. (canceled)

2. (canceled)

3. (canceled)

4. (canceled)

5. (canceled)

6. (canceled)

7. (canceled)

8. A system configured to generate a user interface of a virtual collaboration environment based on a prioritized order of units of work managed within the virtual collaboration environment, the system comprising:
one or more physical processors configured by machine-readable instructions to:
manage, by a server, environment state information maintaining a virtual collaboration environment, the virtual collaboration environment being configured to facilitate interaction by users with the virtual collaboration environment, wherein the users interact with and view the virtual collaboration environment via remotely located client computing platforms communicating with the server over one or more Internet connections, the environment state information defining user records and work unit records, the user records including presence information indicating presence and absence of the users from the virtual collaboration environment, the work unit records defining units of work assigned to the users within the virtual collaboration environment, individual units of work being associated with individual dates, wherein managing the environment state information includes maintaining temporal queues of the units of work assigned to the users, wherein individual temporal queues represent the units of work assigned to individual users organized in chronological order based on the individual dates, the units of work including a first set of units of work assigned to a first user, the first set of units of work being represented in a first temporal queue;
establish the one or more Internet connections between the remotely located client computing platforms and the server;
obtain, by the server, indications that the remotely located client computing platforms are accessing the virtual collaboration environment as a result of the users logging into user accounts associated with the collaboration environment;
update, by the server, the presence information based on the indications the remotely located client computing platforms are accessing the virtual collaboration environment;
in response to the presence information indicating the presence of the individual users following the absence of the individual users, determine, by the server, criteria for prioritizing the units of work, such that in response to the presence information indicating the presence of the first user following the absence of the first user, determine a first set of criteria;
generate, by the server, prioritized queues of the units of work from the temporal queues in accordance with the criteria, wherein the prioritized queues represent subsets of the units of work identified for prioritization, such that a first prioritized queue from the first temporal queue is generated in accordance with the first set of criteria, the first prioritized queue representing of a first subset of units of work from the first set of units of work;
effectuate communication of user interface information from the server to the remotely located client computing platforms so that the remotely located client computing platforms present a user interface of the virtual collaboration environment, the user interface displaying the prioritized queues such that the users access the environment state information defining the units of work identified for prioritization via the prioritized queues, such that the user interface displays the first prioritize queue to facilitate access to the environment state information defining the first subset of units of work by the first user; and
wherein the first set of criteria includes selection criteria and ordering criteria, the selection criteria dictates which of the units of work represented by the first temporal queue are identified for prioritization in the first prioritized queue, and the ordering criteria dictates a prioritized order of the units of work identified for the first prioritized queue, the ordering criteria including roles of creators of the units of work, such that the prioritized order is organized by the roles of the creators of the units of work which is different from the chronological order of the individual dates of the units of work.

9. (canceled)

10. The system of claim 8, wherein the selection criteria dictates selection of the units of work for prioritization based on one or more of a length of a time period of the absence preceding the presence, the units of work having the individual dates that fall within the time period of the absence, or the units of work having the individual dates immediately following the presence, and the ordering criteria further includes ascending by amount of expected workload to complete the units of work or descending by the amount of expected workload to complete the units of work.

11. A method to generate a user interface of a virtual collaboration environment based on a prioritized order of units of work managed within the virtual collaboration environment, the method comprising:
managing, by a server, environment state information maintaining a virtual collaboration environment, the virtual collaboration environment being configured to facilitate interaction by users with the virtual collaboration environment, wherein the users interact with and view the virtual collaboration environment via remotely located client computing platforms communicating with the server over one or more Internet connections, the environment state information defining user records and work unit records, the user records including presence information indicating presence and absence of the users from the virtual collaboration environment, the work unit records defining units of work assigned to the users within the virtual collaboration environment, individual units of work being associated with individual dates, wherein managing the environment state information includes maintaining temporal queues of the units of work assigned to the users, wherein individual temporal queues represent the units of work assigned to individual users organized in chronological order based on the individual dates, the units of work including a first set of units of work assigned to a first user, the first set of units of work being represented in a first temporal queue;
establishing the one or more Internet connections between the remotely located client computing platforms and the server;
obtaining, by the server, indications that the remotely located client computing platforms are accessing the virtual collaboration environment as a result of the users logging into user accounts associated with the collaboration environment;
updating, by the server, the presence information based on the indications the remotely located client computing platforms are accessing the virtual collaboration environment;
in response to the presence information indicating the presence of the individual users following the absence of the individual users, determining, by the server, criteria for prioritizing the units of work, including in response to the presence information indicating the presence of the first user following the absence of the first user, determining a first set of criteria;
generating, by the server, prioritized queues of the units of work from the temporal queues in accordance with the criteria, wherein the prioritized queues represent subsets of the units of work identified for prioritization, including generating a first prioritized queue from the first temporal queue in accordance with the first set of criteria, the first prioritized queue representing of a first subset of units of work from the first set of units of work;
effectuating communication of user interface information from the server to the remotely located client computing platforms so that the remotely located client computing platforms present a user interface of the virtual collaboration environment, the user interface displaying the prioritized queues such that the users access the environment state information defining the units of work identified for prioritization via the prioritized queues, including presenting the first prioritize queue to facilitate access to the environment state information defining the first subset of units of work by the first user; and
wherein the first set of criteria includes selection criteria and ordering criteria, the selection criteria dictates which of the units of work represented by the first temporal queue are identified for prioritization in the first prioritized queue, and the ordering criteria dictates a prioritized order of the units of work identified for the first prioritized queue, the ordering criteria including roles of creators of the units of work, such that the prioritized order is organized by the roles of the creators of the units of work which is different from the chronological order of the individual dates of the units of work.

12. (canceled)

13. The method of claim 11, wherein the selection criteria dictates selection of the units of work for prioritization based on one or more of a length of a time period of the absence preceding the presence, the units of work having the individual dates that fall within the time period of the absence, or the units of work having the individual dates immediately following the presence.

14. (canceled)

15. (canceled)

16. The method of claim 11, wherein the selection criteria dictates selection of a given unit of work for prioritization based on one or more of an association of the given unit of work with a business objective, a dependency of the given unit of work, or an association of the given unit of work with a team of users.

17. (canceled)

18. The method of claim 11, wherein the ordering criteria further includes ascending by amount of expected workload to complete the units of work or descending by the amount of expected workload time to complete the units of work.

19. (canceled)

20. (canceled)
